(19) United States
(12) Patent Application Publication
(10) Pub. No.: US 2022/0018086 A1
(43) Pub. Date: Jan. 20, 2022

(54) Handheld Excavator

(71) Applicant: Adam Schwartz, Franklin, WI (US)

(72) Inventor: Adam Schwartz, Franklin, WI (US)

(21) Appl. No.: 17/372,693

(22) Filed: Jul. 12, 2021

Related U.S. Application Data
(60) Provisional application No. 63/051,963, filed on Jul. 15, 2020.

(51) Int. Cl. E02F 3/14; E02F 3/16; F16M 11/20; F16M 13/02; E02F 9/18; E02F 9/20

(52) U.S. Cl. CPC E02F 3/141; E02F 3/16; E02F 9/2004; F16M 13/02; E02F 9/18; F16M 11/2035

(57) ABSTRACT

The present invention relates to a handheld excavator. The handheld excavator is used for excavating small areas and spaces that are unreachable with a standard excavator. The handheld excavator does not have an operator's seat and can have a four-legged stand, a wheeled stand, or a wall-mounted attachment. The excavator has a 180 degree rotational platform positioned on the stand, a boom extending from the platform, an arm attached to a first end of the boom, and a bucket. The linear and rotational movements of the excavator are controlled by a detachable control panel for remotely operating the handheld excavator. The handheld excavator is powered through built-in batteries and has a hydraulic mechanism for driving the movements.

### CROSS-REFERENCE TO RELATED APPLICATION

The present application claims priority to, and the benefit of, U.S. Provisional Application No. 63/051,963, which was filed on Jul. 15, 2020 and is incorporated herein by reference in its entirety.

### FIELD OF THE INVENTION

The present invention relates generally to the field of excavators. More specifically, the present invention relates to a portable and handheld excavator attached to a 4-leg or wheeled detachable stand, that allows a user to operate the excavator from the stand via a control panel. In an embodiment, the excavator includes a wall mount that allows the excavator to be adjusted to different heights, and can be operated using a control panel device. The invention offers a convenient method of operating excavators for digging trenches and/or holes with ease and from a small distance. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, excavators are used in various types of industries such as forestry, mining and other construction industries. Excavators have been known for digging trenches, holes, foundations, forestry work, demolition, mining and more.

Excavating ground surfaces manually can be incredibly stressful and labor-intensive. Further, manually using a shovel to excavate large areas can take a considerable amount of time. Workers may also be put at risk for possible trench cave-ins, among numerous other potentially dangerous situations. Therefore, excavators are generally used for digging and other similar purposes.

However, conventional excavators are heavy pieces of construction equipment that are expensive and typically unaffordable for individuals to buy or rent. Thus, people often hire excavation services for digging trenches, holes, foundations, forestry work, demolition, mining, etc. The excavation service provider then supplies the excavator and an operator for operating the excavator equipment in order to properly dig holes and/or trenches, foundations and/or perform any other operation as per the requirements of the user. However, standard excavators are quite large and may not be able to be utilized in smaller areas. Thus, standard excavators typically fail to perform functions such as digging holes and/or trenches, etc. in smaller areas due to their size. In such scenarios, people end up manually excavating the intended area which requires substantial effort and time for the users, as noted. Further, elderly people and other people with limited dexterity may not be able to manually excavate surfaces due to the injuries and/or strain it may cause to their bodies.

Therefore, there exists a long-felt need in the art for an excavation device that can be easily used for digging trenches, holes, mining and more. There is also a long-felt need in the art for an excavation device that is small in size and can be operated by the user themselves. Additionally, there is a long-felt need in the art for an excavation device that can be conveniently used for digging trenches and/or holes or for performing other operations in smaller areas. Moreover, there is a long-felt need in the art for an excavation device that can easily fit into smaller spaces. Further, there is a long-felt need in the art for a handheld and portable excavation device that can be easily used by elderly people and people with limited dexterity for excavating ground surfaces without causing strain or injuries to themselves. There is also a long-felt need in the art for an excavation device that eliminates the need for an operator/expert to operate the device and can be easily operated by an individual. Finally, there is a long-felt need in the art for an excavation device that eliminates the need to manually excavate ground surfaces and thereby eliminates the risk of possible trench cave-ins and other potentially dangerous situations.

The subject matter disclosed and claimed herein, in one embodiment thereof, comprises a remotely-controlled handheld excavation device that is configured to excavate small areas and spaces that are unreachable with a standard excavator. The handheld excavation device further comprises a stand having detachable legs, a 180-degree rotational platform positioned on the stand, a first end of a boom attached to a top surface of the platform, an arm attached to a second end of the boom, a bucket detachably attached to the arm for excavation and a detachable control panel attached to the stand for remotely operating the handheld excavation device. In addition, the stand may also be comprised of wheels allowing the device to move easily, and the device may also be powered through built-in batteries.

In this manner, the novel handheld excavation device of the present invention accomplishes all of the forgoing objectives, and provides a relatively safe, easy, and convenient solution to excavate ground surfaces, dig trenches, holes, perform mining and other similar operations that could not be achieved with traditional excavators known in the art. The handheld excavation device can also be operated using a control panel device or a set of detachable controls from a short distance and is therefore user-friendly. Additionally, the handheld excavation device can be operated from safe distances away from the digging area and therefore reduces the risk of injuries to users.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a remotely-controlled handheld excavation device, wherein the device is configured to excavate small areas and spaces that are unreachable with a standard excavator. The handheld excavation device further comprises a stand having detachable legs, a 180-degree rotational platform positioned on the stand, a first end of a boom attached to a top surface of the platform, an arm attached to a second end of the boom, a bucket detachably attached to the arm for excavation and a detachable control panel attached to the stand for remotely operating the handheld excavation device. In addition, the stand may be comprised of wheels allowing the handheld excavation device to move easily. It is also further contemplated that the handheld excavation device is powered through built-in batteries.

In a further embodiment of the present invention, a wall-mounted mini excavator is disclosed. The mini excavator includes a wall mount, a stand extending from and attached to the wall mount wherein the stand is configured to move vertically along a channel of the wall mount, a rotatable platform positioned on the stand wherein the platform includes a plurality of batteries for providing power and a wireless transceiver allowing the excavator to be controlled by a remote controller, a boom extending from a top surface of the platform, an arm attached to the boom through a hinge wherein the arm is configured to pivotally move relative to the boom and a bucket connected to the arm configured for performing a digging operation, i.e., excavating.

In yet a further embodiment of the present invention, a hydraulic handheld excavator is disclosed. The hydraulic handheld excavator includes a hydraulic circuitry coupled to a plurality of hydraulic pumps. Accordingly, the hydraulic circuitry provides pivotal movement of a boom, a boom arm and an excavation bucket. The hydraulic pumps then power the hydraulic circuitry for providing the pivotal movement, wherein the movement is controlled using a detachable control panel having controls for separate movements of the boom, the boom arm and the excavation bucket.

In a further embodiment of the present invention, a compact hydraulic excavator is disclosed. The compact hydraulic excavator is configured to perform excavation in small spaces where a conventional excavator is unreachable. The compact excavator includes a stand, a rotatable platform positioned on the stand, a boom structure extending outwardly from the platform, a pivotal arm attached to the boom, an excavating bucket pivotally secured to the pivotal arm for digging trenches and/or holes wherein the boom structure, a pivotal arm and the excavating bucket are hydraulically operated by a detachably attached control panel.

In yet another embodiment of the present invention, the handheld excavator is designed to excavate small areas, typically unreachable with a standard excavator. The excavator can feature multiple embodiments wherein the rotational platform can be positioned on a four-legged stand, a wheeled stand or a wall-mounted system. Further, buckets of different shapes, sizes and dimensions can be connected to the boom arm to perform various excavations.

In yet another embodiment, the handheld excavator does not have an operator seat and an operator can operate the handheld excavator remotely from a short distance via a detachable control panel. Accordingly, the absence of the operator seat makes it possible to reduce the size of the handheld excavator, and the detachable control panel allows remote control of the handheld excavator from a safe distance. Further, the handheld excavator comprises a boom extended from a rotational platform which rotates 360 degrees.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of one potential embodiment of a handheld excavation device of the present invention in accordance with the disclosed architecture;

FIG. 2 illustrates a perspective view of one potential embodiment of a handheld excavation device of the present invention in use by an operator in accordance with the disclosed architecture;

FIG. 3 illustrates a perspective view of one embodiment of a wall-mounted handheld excavation device of the present invention in accordance with the disclosed architecture;

FIG. 4 illustrates a block diagram showing a wireless connection of the wall-mounted excavation device comprising a control panel connected to a hydraulic pump and battery in accordance with the disclosed architecture; and

FIG. 5 illustrates a perspective view of the control panel attached to the handheld excavation device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention, and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an excavation device that can be easily used for digging trenches, holes, mining and more. There is also a long-felt need in the art for an excavation device that is small in size and can be operated by the owner. Additionally, there is a long-felt need in the art for an excavation device that can be used for digging trenches, holes and for performing other operations in smaller areas that could otherwise not be done via existing large excavators. Further, there is a long-felt need in the art for a handheld, portable excavation device that can be easily used by elderly people and people with limited dexterity to excavate ground surfaces without strain or injury to themselves. Furthermore, there is a long-felt need in the art for an excavation device that eliminates the need for the operator/expert to operate the device, wherein the device can be easily operated by an non-expert individual. Finally, there is a long-felt need in the art for an excavation device that eliminates the need to manually excavate ground surfaces and thereby protects users from the risk of possible trench cave-ins and other potentially dangerous situations.

The present invention, in one exemplary embodiment, discloses a novel wall-mounted excavation device. The excavation device comprises a wall mount, a stand extending from and attached to the wall mount, wherein the stand is configured to move vertically along a channel of the wall mount, a rotatable platform positioned on the stand wherein the rotatable platform includes a plurality of batteries for providing power, and a wireless transceiver allowing the excavation device to be controlled by a remote controller, a boom extending from a top surface of the platform, an arm attached to the boom through a hinge wherein the arm is configured to pivotally move relative to the boom and a bucket connected to the arm configured for performing various digging operations.

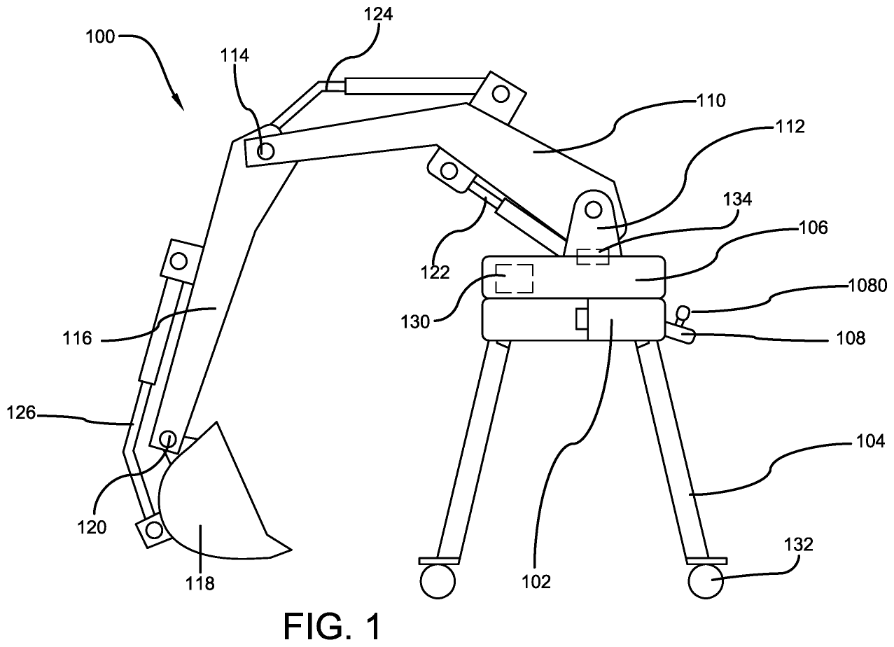

Referring initially to the drawings, FIG. 1 illustrates a perspective view of one potential embodiment of the handheld excavation device of the present invention in accordance with the disclosed architecture. The handheld excavation device 100 functions as a mini excavator designed to excavate small areas which would otherwise be typically unreachable with a standard excavator. In the present embodiment, the excavation device 100 has a four-legged stand 102 comprising four repositionable legs 104 allowing the excavation device 100 to be placed in small and narrow spaces. It should be appreciated that an operator's seat or a cabin is not present in the excavation device 100, thereby allowing the size of the device to be reduced, which increases utility of the excavation device 100. A rotatable platform 106 is also positioned on the top of the stand 102. The rotatable platform 106 is rotatably secured to the stand 102 via any various securing means (such as but not limited to a bearing interface 134) which allows a 360-degree rotation of the platform 106.

A boom 110 then extends from the platform 106 and is secured by a hinged connector 112, or any other suitable connector known in the art, to allow a hinged or pivotal movement. The hinged connector 112 allows the boom 110 to pivotally move relative to the platform 106. Further, the boom 110 is similar to a conventional boom and is powered through a corresponding hydraulic boom cylinder 122. In the present embodiment, the boom 110 is a variable angle boom 110, allowing the boom 110 to change the curvature of rotation using an additional joint 114. A boom arm 116 is also hingedly-connected to the boom 110 at the additional joint 114, thereby allowing the boom arm 116 to provide a longer reach for excavation. Said boom arm 116 is similar to a conventional boom arm and is powered through a corresponding hydraulic cylinder 124.

The functions of the handheld excavation device 100 include the motions of the boom 110, boom arm 116 and an excavation bucket 118. The excavation bucket 118 is pivotally connected to the boom arm 116 at the hinged connector 120. Accordingly, the bucket 118 freely moves along the hinged connector 120 during the excavation process, and is similar to a conventional excavation bucket, wherein the bucket 118 is powered through a corresponding hydraulic cylinder 126. Thus, in the case of the handheld excavation device 100 of the type represented in FIG. 1, the boom 110, the boom arm 116 and the excavation bucket 118 are typically powered with a plurality of hydraulic cylinders 122, 124, and 126 while the rotating platform and other functions can be powered by an internal battery 130 of the excavation device 100.

To operate the excavation device 100, a detachable control panel 108 is removably-attached to the stand 102, thereby allowing an operator to easily control the movements of the excavation device's components i.e., the boom 110, boom arm 116 and the excavation bucket 118. Further, the platform 106 can be rotated in a desired direction using the control panel 108. Specifically, the control panel 108 contains a plurality of operating levers 1080 that can be manually manipulated to control the movements of the boom 110, the boom arm 116 and the excavation bucket 118 in desired directions.

The handheld excavation device 100 also includes, for example, a hydraulic pump (not shown), a plurality of hydraulic actuators including but not limited to: a boom hydraulic cylinder 122, a boom arm hydraulic cylinder 124, a bucket hydraulic cylinder 126 and the like. A plurality of directional control valves can also be connected with the hydraulic cylinders 122, 124, 126 that respectively control the flow of oil within the cylinders 122, 124, 126. Overall, the handheld excavation device 100 is powered and operates in a similar fashion to a conventional excavator via the use of hydraulic pumps and actuators.

In the present embodiment, the stand 102 is portable, thus allowing the excavation device 100 to be easily moved from one site to the other for excavation. In another embodiment, the stand legs 104 can have wheels 132 or casters allowing the operator to manually or through the control panel 108 move the excavation device 100 from one place to another. The platform 106 can also be weighted to counterbalance the weight of the boom110, boom arm 116 and excavation bucket 118 such that the excavation device 100 does not tip over during use.

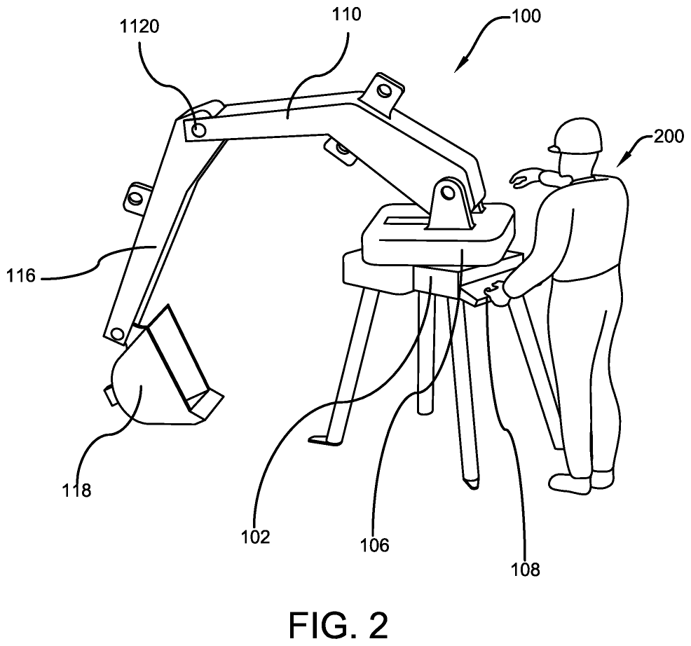

FIG. 2 illustrates a perspective view of one potential embodiment of the handheld excavation device 100 of the present invention in use by an operator 200 in accordance with the disclosed architecture. An operator 200 can easily access the control panel 108 to control the movements of the components such as the boom 110, the boom arm 116 and the excavation bucket 118, along with the rotation of the platform 106. Accordingly, an operator 200 does not need to sit in an operator's cabin or seat for moving and operating the excavation device 100. The operating levers or controls of the control panel 108 are also easily accessible as a user 200 stands beside the excavation device 100 and manipulates the operating levers or controls to send instructions from the control panel 108 to the hydraulic cylinders 122, 124, 126 for controlling the movement of the components.

For example, using one of the operating levers 1080, an independent boom swing is achieved by the operator 200. An independent boom swing would be achieved via a universal hinge 1120 at the joint 114 which allows motion in two planes. The primary purpose of the independent boom swing is to allow for digging around obstacles or along foundations, walls or forms, etc. Accordingly, the independent boom swing allows the boom arm 116 to not only move up and down but also to the left and right. An independent boom swing is one of the major advantages of the compact excavation device 100 of the present invention and adds an increased amount of versatility in the device's use, as opposed to conventional excavators.

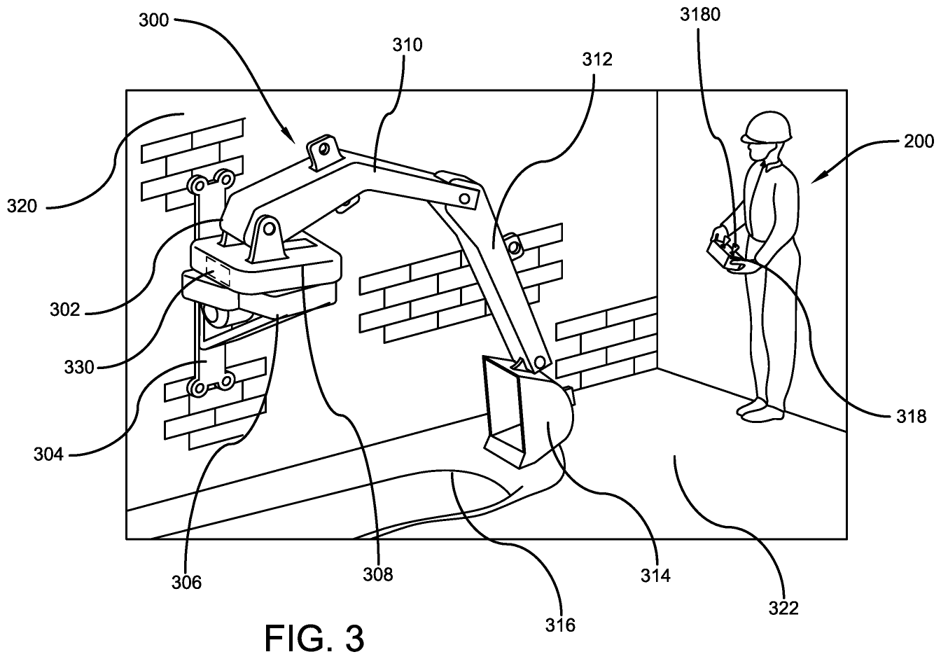

FIG. 3 illustrates a perspective view of another embodiment of the handheld excavation device 100 of the present invention in accordance with the disclosed architecture. In the present embodiment, the handheld excavation device 100 is a wall-mounted excavator 300 and is fastened to a wall 320 using a wall mount attachment 302. The wall mount attachment 302 can be fastened to a conventional wall 320 using mechanical fasteners, or any other suitable fastening means as is known in the art. The wall mount attachment 302 has a channel 304 along its length, thereby allowing a stand 306 of the wall-mounted excavator 300 to move along the channel 304. The movement along the channel 304 allows the wall-mounted excavator 300 to be elevated in height as per the preferences of an operator 200.

The stand 306 further has a rotatable platform 308 positioned on its top surface that can be rotated in a desired direction, wherein a bearing interface 134 is used as the securing means to allow rotation of the platform 308. The wall-mounted excavator 300 also has a boom 310 extending from the platform 308 and is connected to a boom arm 312 for pivotal movement of the boom arm 312. The excavation bucket 314 further excavates a trench or a hole 316 in the ground, or at any desired surface 322.

To operate the wall-mounted excavator 300, an operator 200 has a detachable control panel 318 with a plurality of operating levers 3180 or controllers allowing the operator 200 to control movements of the boom 310, the boom arm 312 and the bucket 314 from a short distance away from the wall-mounted excavator 300. The wall-mounted excavator 300 of the present invention also has a wireless transceiver allowing the motor and the hydraulic pumps to be connected to the control panel 318, thus allowing the operator 200 to wirelessly monitor and control the wall-mounted excavator 300.

It should be appreciated that the wall-mounted excavator 300 of the present invention allows the use of automatic excavation in spaces where a conventional excavator cannot work or reach. The hydraulic system including the hydraulic pumps powered through an internal motor and hydraulic cylinders control the movement of the boom 310, the boom arm 312 and the bucket 314 based on the instructions received from the control panel 318.

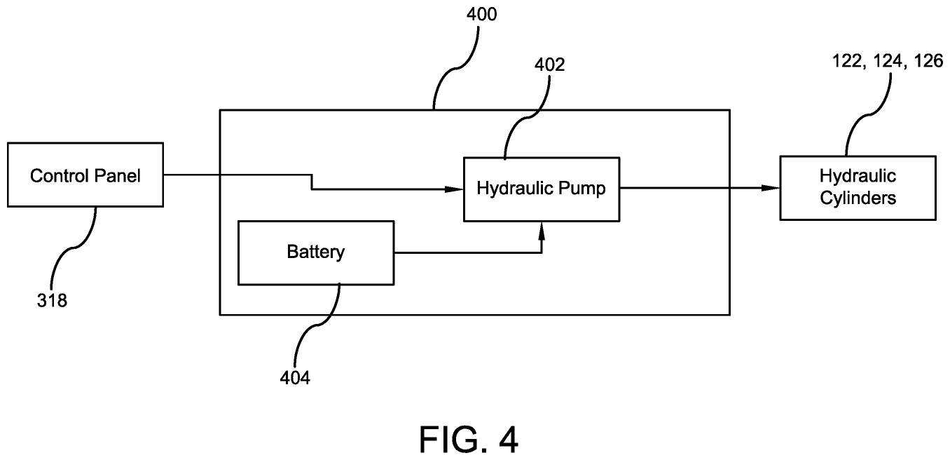

FIG. 4 illustrates a block diagram showing wireless connection of the control panel 318 with hydraulic pump of the wall-mounted excavator 300 in accordance with the disclosed architecture. The control panel 318 is wirelessly-connected to the hydraulic mechanism 400 of the wall-mounted excavator 300 of FIG. 3. The wall-mounted excavator 300 can also have a built-in wireless communication module 330, thereby allowing a wireless communication channel to be established between the control panel 318 and the hydraulic mechanism 400. It should be noted that the hydraulic mechanism 400 can be built-in within the rotating platform 308 or in the stand 306 of the wall-mounted excavator 300. A built-in battery 404 may be present and is connected to the hydraulic pumps 402 for providing the required power. An optional motor can also be connected to the battery 404. The hydraulic pump 402 can be one or more, depending on the size and design of the wall-mounted excavator 300. The hydraulic pump 402 drives the hydraulic cylinders 122, 124, 126 allowing the pivotal movements of the boom, the arm and the bucket of the wall-mounted excavator 300.

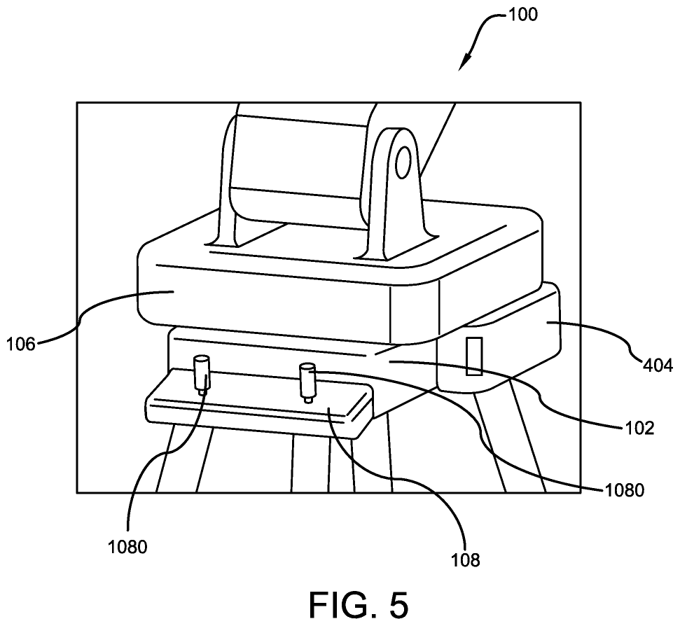

FIG. 5 illustrates a close-up view of the control panel attached to the handheld excavation device 100 of the present invention in accordance with the disclosed architecture. The control panel 108 is detachably-attached to the stand 102 and is comprised of an attached internal battery 404. The control panel 108 is coupled to the hydraulic mechanism of the excavation device 100, thereby allowing the operating levers 1080 to control the movements of the components of the excavation device 100. The operating levers 1080 further allow independent control of the movement of the boom 110, the boom arm 116 and the bucket 118. The control panel 108 is both wireless and a wired mechanism connected to the hydraulic mechanism. The control panel 108 is also used for controlling the rotation of the rotating panel 106.

In one embodiment of the present invention, the excavators 100 and 300 are fully electric and are powered by Lithium-Ion batteries 130. Instead of hydraulic pumps and cylinders, electric cylinders may also be utilized. The excavators 100 and 300 of this embodiment are eco-friendly and generate no exhaust gas, noise and/or heat. In this embodiment, wherein the excavators are electric, the control panel 108 of the excavators 100, 300 can be wireless or a wired mechanism which is attached to the electrical circuitry of the excavator 100, 300 allowing smooth movements of the components of the excavator 100, 300.

In all the embodiments of the present invention, the control panel 108 is detachable from the stand 102 and can be wirelessly-connected to control the excavator 100,300. Further, the hydraulic cylinders 122, 124, 126 allow the pivotal motion of the components of the excavator 100, 300 and the movements are controlled by operating levers 1080 on the control panel 108.

The excavators 100 and 300 of the present invention can have both linear and rotary hydraulic cylinders 122, 124, 126 which act as actuators. The boom 110, the arm 116 and the bucket 118 are replaceable, and can be replaced with different sizes of components based on the wants and/or needs of a user.

Certain terms are used throughout the following description and claims to refer to particular features or components. As one skilled in the art will appreciate, different persons may refer to the same feature or component by different names. This document does not intend to distinguish between components or features that differ in name, but not structure or function. As used herein “handheld excavator”, “remotely controlled handheld excavator”, “mini excavator”, “wall mounted mini excavator”, “hydraulic handheld excavator”, “compact hydraulic excavator”, and “excavator” are interchangeable and refer to the handheld excavator 100 and 300 of the present invention.

Notwithstanding the forgoing, the handheld excavator 100 and 300 of the present invention can be of any suitable size and configuration as is known in the art without affecting the overall concept of the invention, provided that it accomplishes the above-stated objectives. One of ordinary skill in the art will appreciate that the size, configuration and material of the handheld excavator 100 and 300 as shown in FIGS. 1-5 are for illustrative purposes only, and that many other sizes and shapes of the handheld excavator 100 and 300 are well within the scope of the present disclosure. Although the dimensions of the handheld excavator 100 and 300 are important design parameters for user convenience, the handheld excavator 100 and 300 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A handheld excavation device comprising:
a stand comprising four legs;
a rotatable platform positioned on the stand;
a boom which extends from the rotatable platform, wherein the boom is secured to the rotatable platform by a hinged connector;
a boom arm hingedly connected to the boom;
an excavation bucket hingedly connected to the boom arm; and
a removable control panel for controlling movement of the boom, the boom arm, and the excavation bucket.

2. The handheld excavation device of claim 1, wherein the rotatable platform rotates 360 degrees.

3. The handheld excavation device of claim 2, wherein the rotatable platform is secured to the stand via a bearing interface.

4. The handheld excavation device of claim 3, wherein the stand does not comprise an operator's seat or cabin, but is positioned resting on the four legs on a ground surface.

5. The handheld excavation device of claim 4, wherein each of the boom, the boom arm, and the excavation bucket are powered via a corresponding hydraulic cylinder.

6. The handheld excavation device of claim 5, wherein the rotatable platform is powered by an internal battery.

7. The handheld excavation device of claim 1, wherein the boom arm is hingedly connected to the boom at an additional joint which allows the boom arm to provide a long reach for excavation.

8. The handheld excavation device of claim 7, wherein the removable control panel is wireless and can be removed from the handheld excavation device.

9. The handheld excavation device of claim 8, wherein the removable control panel comprises a plurality of operating levers to be manipulated by a user.

10. The handheld excavation device of claim 1, wherein each of the four legs comprise a wheel or a caster.

11. The handheld excavation device of claim 1, wherein the platform is weighted to counterbalance a weight of the boom, the boom arm, and the excavation bucket such that the handheld excavation device does not tip over during use.

12. The handheld excavation device of claim 1, wherein the boom arm comprises a universal hinge which allows motion in at least two planes.

13. A wall mounted excavator comprising:
a wall mount attachment for fastening the excavator to a wall;
a stand secured to the wall mount attachment;
a rotatable platform positioned on the stand;
a boom which extends from the rotatable platform and is secured by a hinged connector to the rotatable platform;
a boom arm hingedly connected to the boom; and
an excavation bucket hingedly connected to the boom arm; and
a removable control panel for controlling each of the boom, the boom arm, and the excavation bucket.

14. The wall mounted excavator of claim 13, wherein the wall mount attachment is fastened to a conventional wall using a plurality of mechanical fasteners.

15. The wall mounted excavator of claim 14, wherein the wall mount attachment comprises a channel along its length such that the stand can move along the channel which raises or lowers a height of the wall mounted excavator.

16. The wall mounted excavator of claim 15, wherein the rotatable platform is secured to the stand via a bearing interface.

17. The wall mounted excavator of claim 13, wherein the removable control panel is wireless and can be removed from the wall mounted excavator.

18. The wall mounted excavator of claim 13, wherein the boom arm comprises a universal hinge which allows motion in two planes, such that the boom arm moves up and down and left and right.

19. The wall mounted excavator of claim 13, wherein the rotatable platform is powered by an internal battery.

20. An excavation device comprising:
a stand;
a rotatable platform positioned on the stand;
a boom which extends from the rotatable platform and is secured by a hinged connector to the rotatable platform;
a boom arm hingedly connected to the boom and comprising a universal hinge which allows motion in two planes, such that the boom arm moves up and down and left and right;
an excavation bucket hingedly connected to the boom arm; and
a control panel that controls a movement of each of the boom, the boom arm, and the excavation bucket, wherein the excavation device is able to be mounted on a wall or positioned directly on a ground surface via the stand.
